(19) United States
(12) Patent Application Publication
(10) Pub. No.: US 2018/0060174 A1
(43) Pub. Date: Mar. 1, 2018

(54) Multiplying width and threshold for improved performance and efficiency

(71) Applicant: International Business Machines Corporation, Armonk, NY (US)

(72) Inventor: Jason K. Resch, Chicago, IL (US)

(21) Appl. No.: 15/805,464

(22) Filed: Nov. 7, 2017

Related U.S. Application Data
(63) Continuation-in-part of application No. 15/242,858, filed on Aug. 22, 2016.
Application No. 15/242,858 is a continuation of application No. 14/256,205, filed on Apr. 18, 2014, now Pat. No. 9,424,132.
(60) Provisional application No. 61/828,883, filed on May 30, 2013.

(51) Int. Cl. G06F 11/10; G06F 11/30; H04L 29/08; G06F 3/06; G06F 11/34; G06F 11/14

(52) U.S. Cl. CPC G06F 11/1092; G06F 11/3034; H04L 67/10; G06F 3/067; G06F 3/0659; G06F 3/064; G06F 11/3433; G06F 11/3419; G06F 11/1458; G06F 11/1456; G06F 11/1453; G06F 11/349; G06F 11/3485; G06F 3/0619; G06F 3/06; G06F 2211/1028

(57) ABSTRACT

A method for execution by a dispersed storage network (DSN), the method begins by receiving data for storage in the DSN. The method continues by selecting a set of storage units, identifying a baseline pillar width and a baseline decode threshold, determining an estimated performance of the set of storage units, determining a parameter multiple based on the estimated performance and the baseline pillar width and the baseline decode threshold, multiplying the parameter multiple by each of the baseline pillar width and the baseline decode threshold to produce a pillar width and a decode threshold, encoding the data using a dispersed storage error coding function in accordance with the pillar width and the decode threshold to produce a plurality of sets of encoded data slices, facilitating storage of the plurality of sets of encoded data slices in the set of storage units and storing the parameter multiple.

### CROSS-REFERENCE TO RELATED APPLICATIONS

The present U.S. Utility patent application claims priority pursuant to 35 U.S.C. §120 as a continuation-in-part of U.S. Utility application Ser. No. 15/242,858 entitled “ADJUSTING DISPERSED STORAGE NETWORK TRAFFIC DUE TO REBUILDING,” filed Aug. 22, 2016, which is a continuation of U.S. Utility application Ser. No. 14/256,205, entitled “ADJUSTING DISPERSED STORAGE NETWORK TRAFFIC DUE TO REBUILDING”, filed Apr. 18, 2014, now U.S. Pat. No. 9,424,132 issued on Aug. 23, 2016, which claims priority pursuant to 35 U.S.C. §119(e) to U.S. Provisional Application No. 61/828,883, entitled “ACCESSING DATA IN A DISPERSED STORAGE NETWORK”, filed May 30, 2013, all of which are hereby incorporated herein by reference in their entirety and made part of the present U.S. Utility Patent Application for all purposes.

### STATEMENT REGARDING FEDERALLY SPONSORED RESEARCH OR DEVELOPMENT

Not applicable.

### INCORPORATION-BY-REFERENCE OF MATERIAL SUBMITTED ON A COMPACT DISC

Not applicable.

### BACKGROUND OF THE INVENTION

### Technical Field of the Invention

This invention relates generally to computer networks and more particularly to dispersing error encoded data.

### Description of Related Art

Computing devices are known to communicate data, process data, and/or store data. Such computing devices range from wireless smart phones, laptops, tablets, personal computers (PC), work stations, and video game devices, to data centers that support millions of web searches, stock trades, or on-line purchases every day. In general, a computing device includes a central processing unit (CPU), a memory system, user input/output interfaces, peripheral device interfaces, and an interconnecting bus structure.

As is further known, a computer may effectively extend its CPU by using “cloud computing” to perform one or more computing functions (e.g., a service, an application, an algorithm, an arithmetic logic function, etc.) on behalf of the computer. Further, for large services, applications, and/or functions, cloud computing may be performed by multiple cloud computing resources in a distributed manner to improve the response time for completion of the service, application, and/or function. For example, Hadoop is an open source software framework that supports distributed applications enabling application execution by thousands of computers.

In addition to cloud computing, a computer may use “cloud storage” as part of its memory system. As is known, cloud storage enables a user, via its computer, to store files, applications, etc. on an Internet storage system. The Internet storage system may include a RAID (redundant array of independent disks) system and/or a dispersed storage system that uses an error correction scheme to encode data for storage.

### BRIEF DESCRIPTION OF THE SEVERAL VIEWS OF THE DRAWING(S)

FIG. 1 is a schematic block diagram of an embodiment of a dispersed or distributed storage network (DSN) in accordance with the present invention;

FIG. 2 is a schematic block diagram of an embodiment of a computing core in accordance with the present invention;

FIG. 3 is a schematic block diagram of an example of dispersed storage error encoding of data in accordance with the present invention;

FIG. 4 is a schematic block diagram of a generic example of an error encoding function in accordance with the present invention;

FIG. 5 is a schematic block diagram of a specific example of an error encoding function in accordance with the present invention;

FIG. 6 is a schematic block diagram of an example of a slice name of an encoded data slice (EDS) in accordance with the present invention;

FIG. 7 is a schematic block diagram of an example of dispersed storage error decoding of data in accordance with the present invention;

FIG. 8 is a schematic block diagram of a generic example of an error decoding function in accordance with the present invention;

FIG. 9 is a schematic block diagram of another embodiment of a dispersed storage network (DSN) system in accordance with the present invention; and

FIG. 9A is a logic diagram of an example method illustrating accessing data in accordance with the present invention.

### DETAILED DESCRIPTION OF THE INVENTION

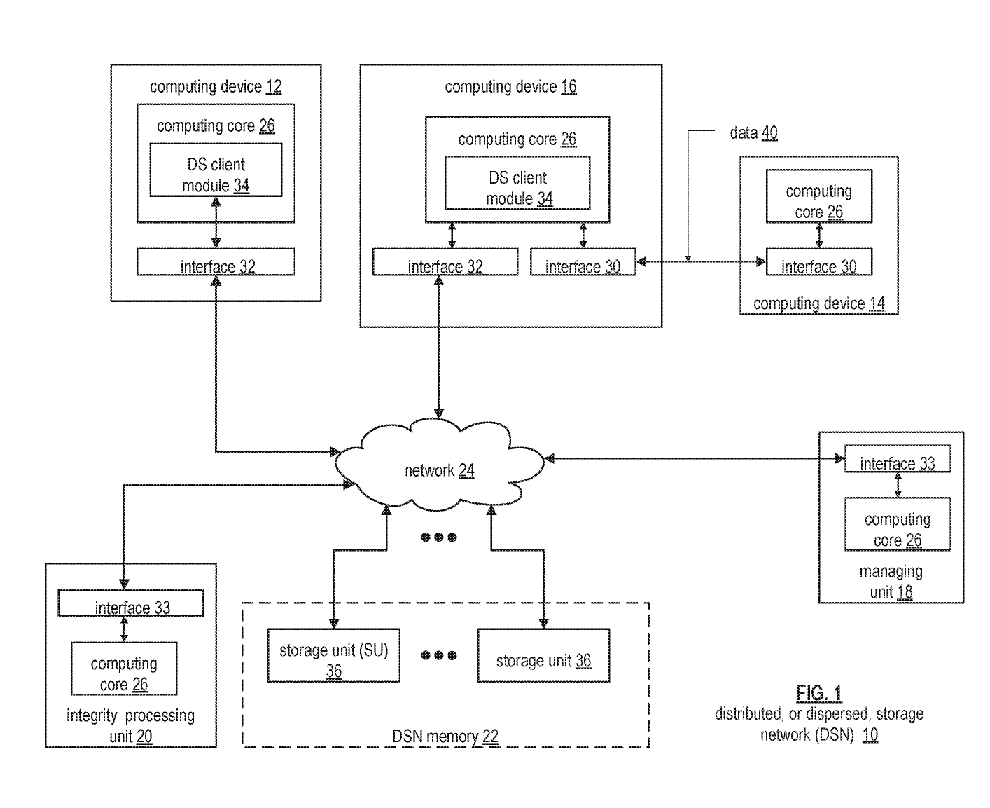

FIG. 1 is a schematic block diagram of an embodiment of a dispersed, or distributed, storage network (DSN) 10 that includes a plurality of computing devices 12-16, a managing unit 18, an integrity processing unit 20, and a DSN memory 22. The components of the DSN 10 are coupled to a network 24, which may include one or more wireless and/or wire lined communication systems; one or more non-public intranet systems and/or public internet systems; and/or one or more local area networks (LAN) and/or wide area networks (WAN).

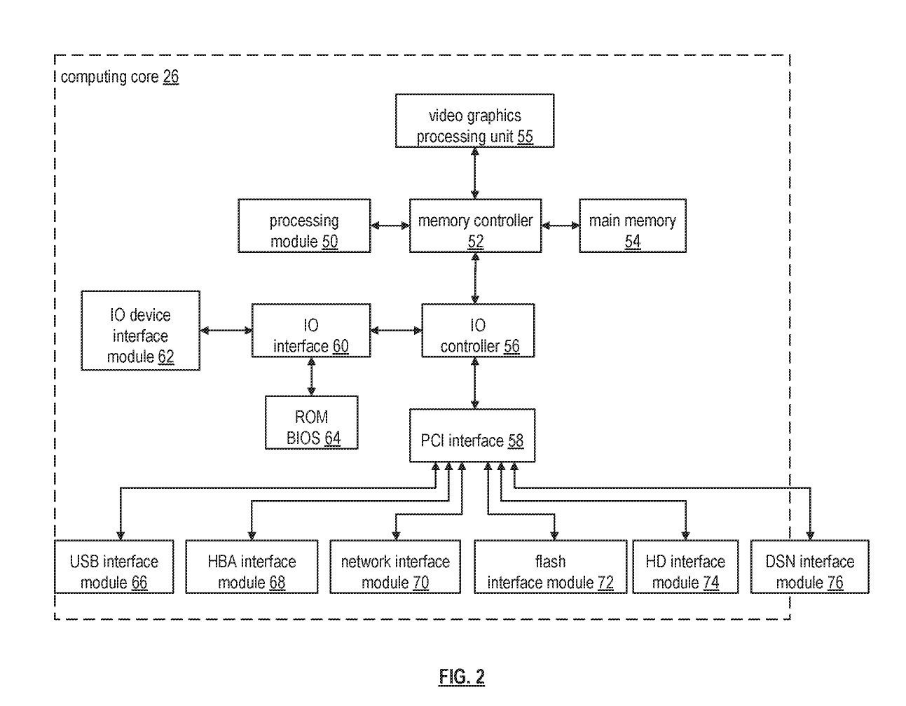

The DSN memory 22 includes a plurality of storage units 36 that may be located at geographically different sites (e.g., one in Chicago, one in Milwaukee, etc.), at a common site, or a combination thereof. For example, if the DSN memory 22 includes eight storage units 36, each storage unit is located at a different site. As another example, if the DSN memory 22 includes eight storage units 36, all eight storage units are located at the same site. As yet another example, if the DSN memory 22 includes eight storage units 36, a first pair of storage units are at a first common site, a second pair of storage units are at a second common site, a third pair of storage units are at a third common site, and a fourth pair of storage units are at a fourth common site. Note that a DSN memory 22 may include more or less than eight storage units 36. Further note that each storage unit 36 includes a computing core (as shown in FIG. 2, or components thereof) and a plurality of memory devices for storing dispersed error encoded data.

Each of the computing devices 12-16, the managing unit 18, and the integrity processing unit 20 include a computing core 26, which includes network interfaces 30-33. Computing devices 12-16 may each be a portable computing device and/or a fixed computing device. A portable computing device may be a social networking device, a gaming device, a cell phone, a smart phone, a digital assistant, a digital music player, a digital video player, a laptop computer, a handheld computer, a tablet, a video game controller, and/or any other portable device that includes a computing core. A fixed computing device may be a computer (PC), a computer server, a cable set-top box, a satellite receiver, a television set, a printer, a fax machine, home entertainment equipment, a video game console, and/or any type of home or office computing equipment. Note that each of the managing unit 18 and the integrity processing unit 20 may be separate computing devices, may be a common computing device, and/or may be integrated into one or more of the computing devices 12-16 and/or into one or more of the storage units 36.

Each interface 30, 32, and 33 includes software and hardware to support one or more communication links via the network 24 indirectly and/or directly. For example, interface 30 supports a communication link (e.g., wired, wireless, direct, via a LAN, via the network 24, etc.) between computing devices 14 and 16. As another example, interface 32 supports communication links (e.g., a wired connection, a wireless connection, a LAN connection, and/or any other type of connection to/from the network 24) between computing devices 12 & 16 and the DSN memory 22. As yet another example, interface 33 supports a communication link for each of the managing unit 18 and the integrity processing unit 20 to the network 24.

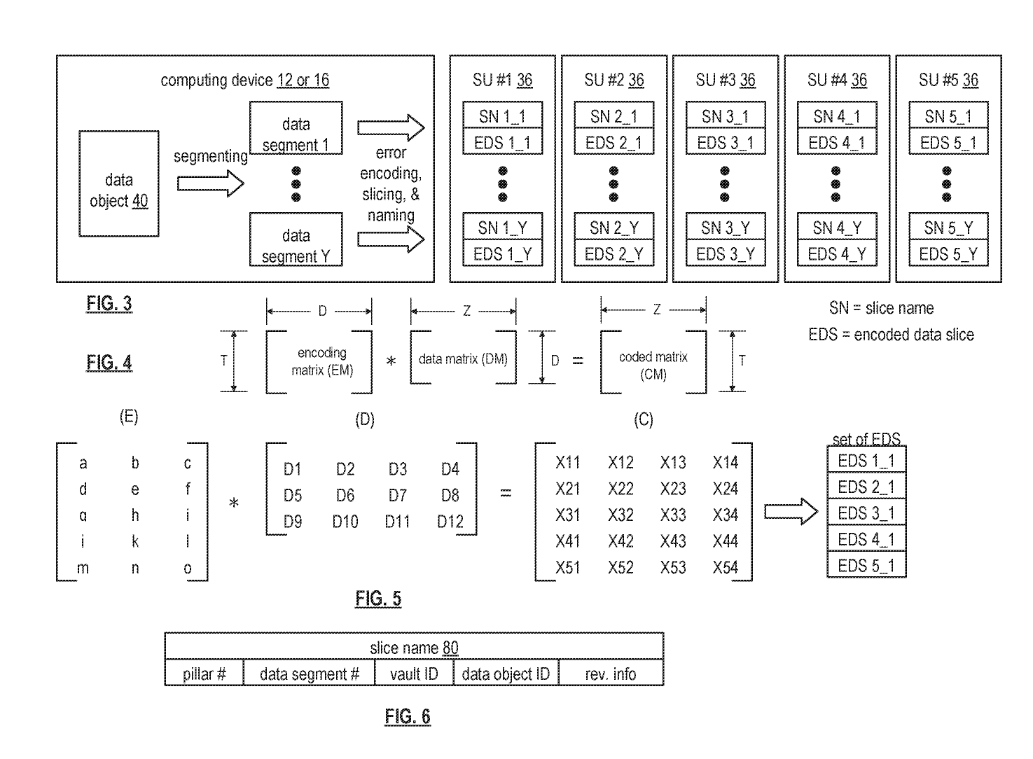

Computing devices 12 and 16 include a dispersed storage (DS) client module 34, which enables the computing device to dispersed storage error encode and decode data as subsequently described with reference to one or more of FIGS. 3-8. In this example embodiment, computing device 16 functions as a dispersed storage processing agent for computing device 14. In this role, computing device 16 dispersed storage error encodes and decodes data on behalf of computing device 14. With the use of dispersed storage error encoding and decoding, the DSN 10 is tolerant of a significant number of storage unit failures (the number of failures is based on parameters of the dispersed storage error encoding function) without loss of data and without the need for a redundant or backup copies of the data. Further, the DSN 10 stores data for an indefinite period of time without data loss and in a secure manner (e.g., the system is very resistant to unauthorized attempts at accessing the data).

In operation, the managing unit 18 performs DS management services. For example, the managing unit 18 establishes distributed data storage parameters (e.g., vault creation, distributed storage parameters, security parameters, billing information, user profile information, etc.) for computing devices 12-14 individually or as part of a group of user devices. As a specific example, the managing unit 18 coordinates creation of a vault (e.g., a virtual memory block associated with a portion of an overall namespace of the DSN) within the DSTN memory 22 for a user device, a group of devices, or for public access and establishes per vault dispersed storage (DS) error encoding parameters for a vault. The managing unit 18 facilitates storage of DS error encoding parameters for each vault by updating registry information of the DSN 10, where the registry information may be stored in the DSN memory 22, a computing device 12-16, the managing unit 18, and/or the integrity processing unit 20.

The DSN managing unit 18 creates and stores user profile information (e.g., an access control list (ACL)) in local memory and/or within memory of the DSN memory 22. The user profile information includes authentication information, permissions, and/or the security parameters. The security parameters may include encryption/decryption scheme, one or more encryption keys, key generation scheme, and/or data encoding/decoding scheme.

The DSN managing unit 18 creates billing information for a particular user, a user group, a vault access, public vault access, etc. For instance, the DSTN managing unit 18 tracks the number of times a user accesses a non-public vault and/or public vaults, which can be used to generate per-access billing information. In another instance, the DSTN managing unit 18 tracks the amount of data stored and/or retrieved by a user device and/or a user group, which can be used to generate per-data-amount billing information.

As another example, the managing unit 18 performs network operations, network administration, and/or network maintenance. Network operations includes authenticating user data allocation requests (e.g., read and/or write requests), managing creation of vaults, establishing authentication credentials for user devices, adding/deleting components (e.g., user devices, storage units, and/or computing devices with a DS client module 34) to/from the DSN 10, and/or establishing authentication credentials for the storage units 36. Network administration includes monitoring devices and/or units for failures, maintaining vault information, determining device and/or unit activation status, determining device and/or unit loading, and/or determining any other system level operation that affects the performance level of the DSN 10. Network maintenance includes facilitating replacing, upgrading, repairing, and/or expanding a device and/or unit of the DSN 10.

The integrity processing unit 20 performs rebuilding of ‘bad’ or missing encoded data slices. At a high level, the integrity processing unit 20 performs rebuilding by periodically attempting to retrieve/list encoded data slices, and/or slice names of the encoded data slices, from the DSN memory 22. For retrieved encoded slices, they are checked for errors due to data corruption, outdated version, etc. If a slice includes an error, it is flagged as a ‘bad’ slice. For encoded data slices that were not received and/or not listed, they are flagged as missing slices. Bad and/or missing slices are subsequently rebuilt using other retrieved encoded data slices that are deemed to be good slices to produce rebuilt slices. The rebuilt slices are stored in the DSTN memory 22.

FIG. 2 is a schematic block diagram of an embodiment of a computing core 26 that includes a processing module 50, a memory controller 52, main memory 54, a video graphics processing unit 55, an input/output (IO) controller 56, a peripheral component interconnect (PCI) interface 58, an IO interface module 60, at least one IO device interface module 62, a read only memory (ROM) basic input output system (BIOS) 64, and one or more memory interface modules. The one or more memory interface module(s) includes one or more of a universal serial bus (USB) interface module 66, a host bus adapter (HBA) interface module 68, a network interface module 70, a flash interface module 72, a hard drive interface module 74, and a DSN interface module 76.

The DSN interface module 76 functions to mimic a conventional operating system (OS) file system interface (e.g., network file system (NFS), flash file system (FFS), disk file system (DFS), file transfer protocol (FTP), web-based distributed authoring and versioning (WebDAV), etc.) and/or a block memory interface (e.g., small computer system interface (SCSI), internet small computer system interface (iSCSI), etc.). The DSN interface module 76 and/or the network interface module 70 may function as one or more of the interface 30-33 of FIG. 1. Note that the IO device interface module 62 and/or the memory interface modules 66-76 may be collectively or individually referred to as IO ports.

FIG. 3 is a schematic block diagram of an example of dispersed storage error encoding of data. When a computing device 12 or 16 has data to store it disperse storage error encodes the data in accordance with a dispersed storage error encoding process based on dispersed storage error encoding parameters. The dispersed storage error encoding parameters include an encoding function (e.g., information dispersal algorithm, Reed-Solomon, Cauchy Reed-Solomon, systematic encoding, non-systematic encoding, on-line codes, etc.), a data segmenting protocol (e.g., data segment size, fixed, variable, etc.), and per data segment encoding values. The per data segment encoding values include a total, or pillar width, number (T) of encoded data slices per encoding of a data segment i.e., in a set of encoded data slices); a decode threshold number (D) of encoded data slices of a set of encoded data slices that are needed to recover the data segment; a read threshold number (R) of encoded data slices to indicate a number of encoded data slices per set to be read from storage for decoding of the data segment; and/or a write threshold number (W) to indicate a number of encoded data slices per set that must be accurately stored before the encoded data segment is deemed to have been properly stored. The dispersed storage error encoding parameters may further include slicing information (e.g., the number of encoded data slices that will be created for each data segment) and/or slice security information (e.g., per encoded data slice encryption, compression, integrity checksum, etc.).

In the present example, Cauchy Reed-Solomon has been selected as the encoding function (a generic example is shown in FIG. 4 and a specific example is shown in FIG. 5); the data segmenting protocol is to divide the data object into fixed sized data segments; and the per data segment encoding values include: a pillar width of 5, a decode threshold of 3, a read threshold of 4, and a write threshold of 4. In accordance with the data segmenting protocol, the computing device 12 or 16 divides the data (e.g., a file (e.g., text, video, audio, etc.), a data object, or other data arrangement) into a plurality of fixed sized data segments (e.g., 1 through Y of a fixed size in range of Kilo-bytes to Tera-bytes or more). The number of data segments created is dependent of the size of the data and the data segmenting protocol.

The computing device 12 or 16 then disperse storage error encodes a data segment using the selected encoding function (e.g., Cauchy Reed-Solomon) to produce a set of encoded data slices. FIG. 4 illustrates a generic Cauchy Reed-Solomon encoding function, which includes an encoding matrix (EM), a data matrix (DM), and a coded matrix (CM). The size of the encoding matrix (EM) is dependent on the pillar width number (T) and the decode threshold number (D) of selected per data segment encoding values. To produce the data matrix (DM), the data segment is divided into a plurality of data blocks and the data blocks are arranged into D number of rows with Z data blocks per row. Note that Z is a function of the number of data blocks created from the data segment and the decode threshold number (D). The coded matrix is produced by matrix multiplying the data matrix by the encoding matrix.

FIG. 5 illustrates a specific example of Cauchy Reed-Solomon encoding with a pillar number (T) of five and decode threshold number of three. In this example, a first data segment is divided into twelve data blocks (D1-D12). The coded matrix includes five rows of coded data blocks, where the first row of X11-X14 corresponds to a first encoded data slice (EDS 1_1), the second row of X21-X24 corresponds to a second encoded data slice (EDS 2_1), the third row of X31-X34 corresponds to a third encoded data slice (EDS 3_1), the fourth row of X41-X44 corresponds to a fourth encoded data slice (EDS 4_1), and the fifth row of X51-X54 corresponds to a fifth encoded data slice (EDS 5_1). Note that the second number of the EDS designation corresponds to the data segment number.

Returning to the discussion of FIG. 3, the computing device also creates a slice name (SN) for each encoded data slice (EDS) in the set of encoded data slices. A typical format for a slice name 60 is shown in FIG. 6. As shown, the slice name (SN) 60 includes a pillar number of the encoded data slice (e.g., one of 1-T), a data segment number (e.g., one of 1-Y), a vault identifier (ID), a data object identifier (ID), and may further include revision level information of the encoded data slices. The slice name functions as, at least part of, a DSN address for the encoded data slice for storage and retrieval from the DSN memory 22.

As a result of encoding, the computing device 12 or 16 produces a plurality of sets of encoded data slices, which are provided with their respective slice names to the storage units for storage. As shown, the first set of encoded data slices includes EDS 1_1 through EDS 5_1 and the first set of slice names includes SN 1_1 through SN 5_1 and the last set of encoded data slices includes EDS 1_Y through EDS 5_Y and the last set of slice names includes SN 1_Y through SN 5_Y.

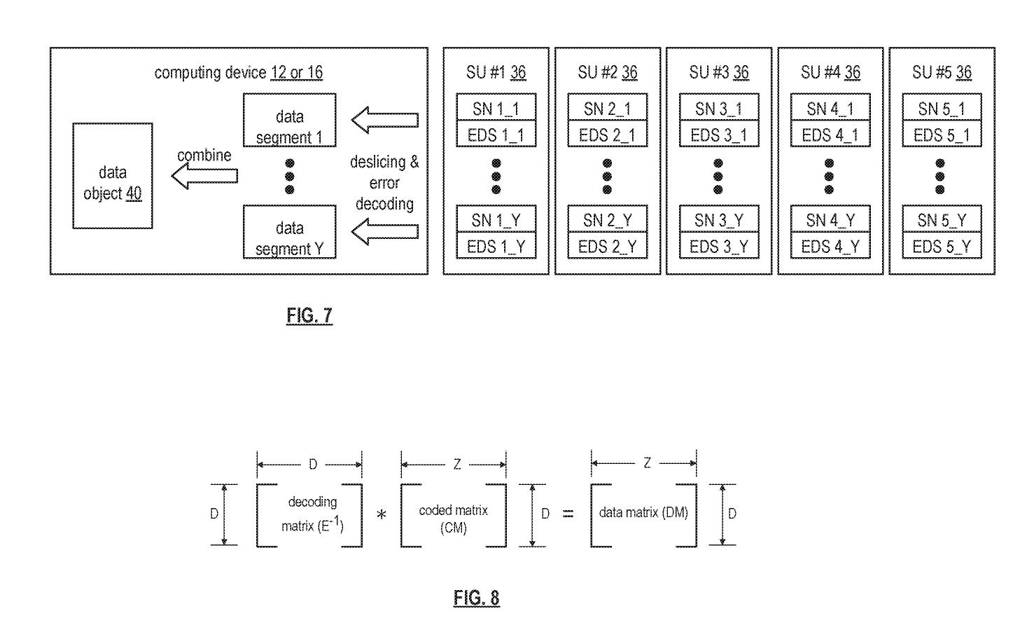

FIG. 7 is a schematic block diagram of an example of dispersed storage error decoding of a data object that was dispersed storage error encoded and stored in the example of FIG. 4. In this example, the computing device 12 or 16 retrieves from the storage units at least the decode threshold number of encoded data slices per data segment. As a specific example, the computing device retrieves a read threshold number of encoded data slices.

To recover a data segment from a decode threshold number of encoded data slices, the computing device uses a decoding function as shown in FIG. 8. As shown, the decoding function is essentially an inverse of the encoding function of FIG. 4. The coded matrix includes a decode threshold number of rows (e.g., three in this example) and the decoding matrix in an inversion of the encoding matrix that includes the corresponding rows of the coded matrix. For example, if the coded matrix includes rows 1, 2, and 4, the encoding matrix is reduced to rows 1, 2, and 4, and then inverted to produce the decoding matrix.

In a standard width and threshold, a threshold number of slices from a threshold number of DS (dispersed or distributed storage) units must be received before decoding can be performed. However, in a dispersed storage system, some DS units may be further away, be under greater load, have more expensive bandwidth metering, or otherwise be slower. In one embodiment, to mitigate the differences in performance or cost, the attributes of an IDA (Information Dispersal Algorithm), such as dispersed storage error coding function parameters discussed further below, are multiplied.

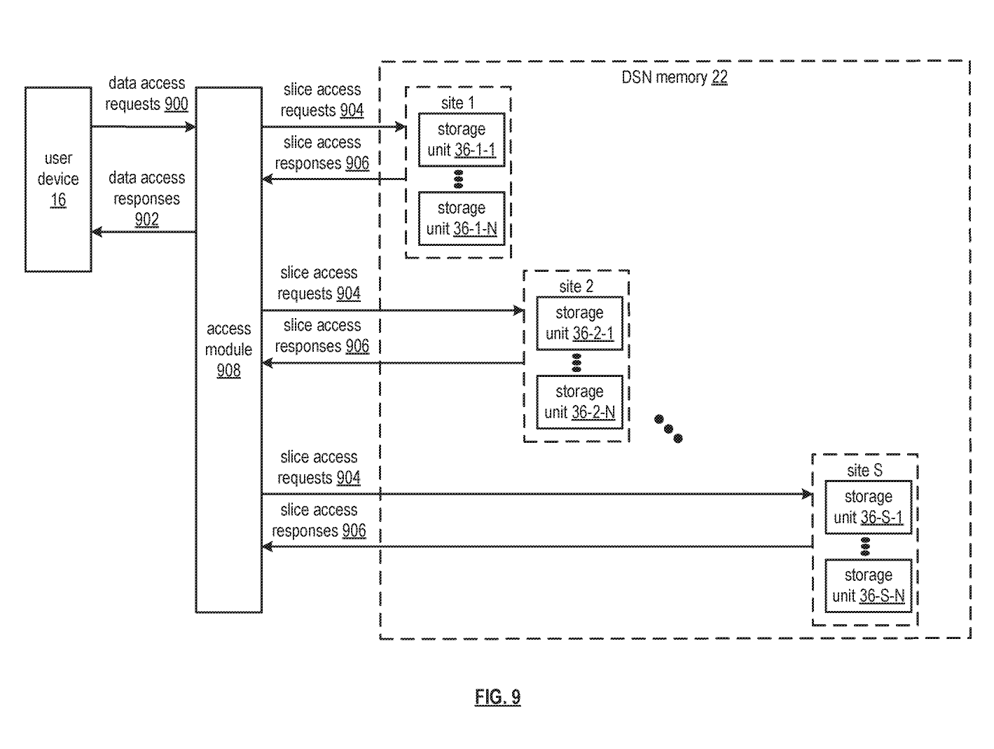

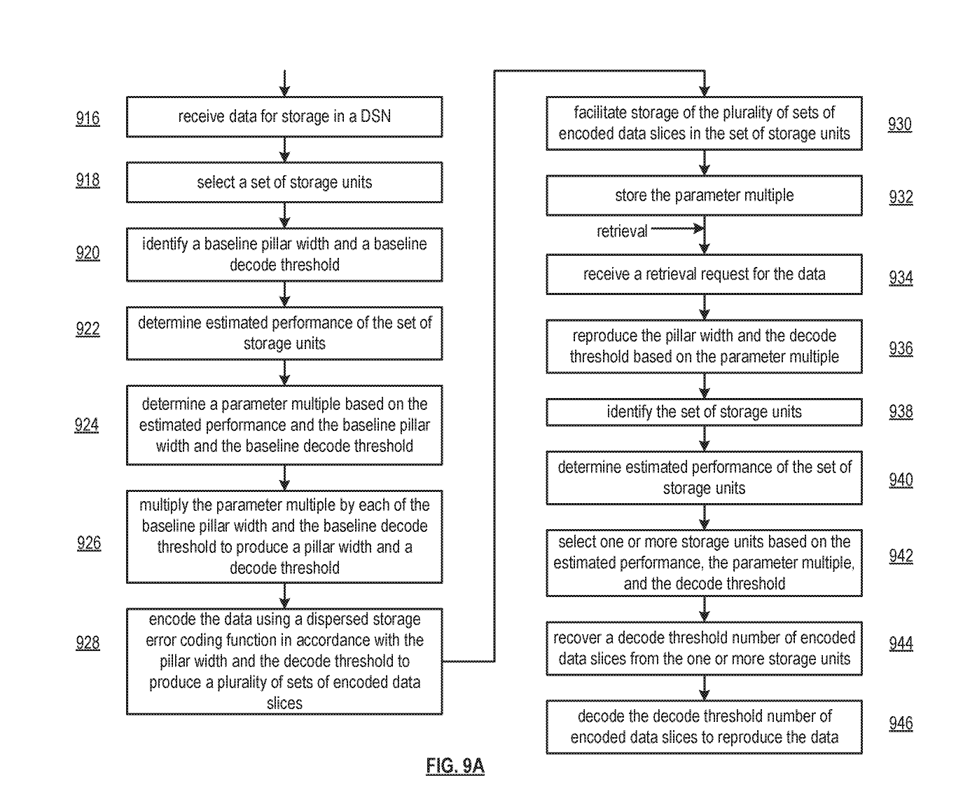

FIG. 9 is a schematic block diagram of another embodiment of a dispersed storage network (DSN) system that includes a user device 16, an access module 908 (e.g., a dispersed storage (DS) processing module, a DS processing unit, a dispersed storage and task (DST) client module), and a dispersed storage network (DSN) memory. The DSN memory 22 includes a plurality of S storage sites, where each site includes one or more storage units. Storage units 36 of the plurality of sites form a set of storage units for storage of one or more sets of encoded data slices, where a data segment is encoded using a dispersed storage error coding function to produce the one or more sets of encoded data slices. Access performance between the access module and each site of the plurality of sites may vary from site to site based on one or more of network loading, network connectivity capabilities, network availability, network connectivity costs, distance between the access module and the site, storage unit performance capability, and storage unit loading.

The system is operable to encode the data using the dispersed storage error coding function in accordance with dispersed storage error coding function parameters, where a parameter multiple of baseline parameters is utilized as the dispersed storage error coding function parameters. The dispersed storage error coding function parameters include at least a pillar width number and a decode threshold number. For example, the system encodes data using dispersed storage error coding function parameters that includes a pillar width of 45 and a decode threshold of 30 when original baseline parameters include a baseline pillar width of 15, a baseline decode threshold number of 10, and a parameter multiple of 3. As another example, the system encodes the data using dispersed storage error coding function parameters that includes a pillar width of 15 and a decode threshold of 10 when baseline parameters includes the baseline pillar width of 15 and the baseline decode threshold number of 10 and a parameter multiple is 1.

System storage and retrieval performance may be enhanced by accessing more encoded data slices via storage units associated with better performance than other storage units. For example, enhanced performance may be provided when accessing slices using one or more storage units at site 1 rather than using one or more storage units at site 3 when access performance between the access module and site 1 is superior (e.g., faster access) to access performance between the access module and site 3. For instance, the access module accesses three slices per storage unit of the one or more storage units at site 1 when the parameter multiple is 3.

In an example of operation of the access module when storing data, the access module receives data for storage as a data access request 900 from user device 16. The access module 908 selects the set of storage units. The access module identifies a baseline pillar width and a baseline decode threshold. The identifying includes at least one of performing a lookup based on an identifier associated with one or more of the user device, the data access request, or a vault identifier. The access module determines estimated performance of each storage unit of the set of storage units (e.g., initiating a test, issuing a query, performing a lookup). The access module determines the parameter multiple based on the estimated performance, the baseline pillar width, and the baseline decode threshold. The access module multiplies the parameter multiple by each of the baseline pillar width and the baseline decode threshold to produce a pillar width and a decode threshold respectively. The access module encodes the data using the dispersed storage error coding function and in accordance with the pillar width and the decode threshold to produce a plurality of sets of encoded data slices. The access module facilitates storing the plurality of sets of encoded data slices in the set of storage units, where each storage unit receives a parameter multiple number of encoded data slices for each set of encoded data slices of the plurality of sets of encoded data slices. The facilitating includes generating a slice access requests 904 for each storage unit of the set of storage units, where the slice access requests includes write slice requests that includes, for each storage unit, the parameter multiple number of encoded data slices. The access module stores the parameter multiplier in one or more of a vault, a directory, or a hierarchical dispersed index. The access module may issue a data access response 902 to the user device that includes confirmation of storage of the data.

In an example of operation of the access module when retrieving data, the access module receives a data access request 900 from the user device 16 that includes a data retrieval request for the data. The access module recovers the parameter multiple and retrieves the baseline decode threshold number and the baseline pillar width. The access module reproduces the pillar width number and the decode threshold number by multiplying the recovered parameter multiple by the retrieved baseline pillar width number and the baseline decode threshold number. The access module identifies the set of storage units. The access module determines an updated estimated performance of the set of storage units.

The access module selects one or more storage units of the set of storage units based on the updated estimated performance of the set of storage units and the recovered parameter multiple. For example, the access module selects storage units associated with best estimated performance of the set of storage units such that a parameter multiple number of encoded data slices are to be retrieved from each of the selected storage units to produce at least a decode threshold number of retrieved encoded data slices. The access module facilitates recovering the decode threshold number of retrieved encoded data slices from the selected storage units. For example, the access module generates slice access requests 904 for each storage unit of the selected storage units to request retrieval of the parameter multiple number of encoded data slices. Next the access module issues the slice access requests to the selected storage units. The access module receives slice access responses 906 from the selected storage units to recover the decode threshold number of retrieved encoded data slices. The access module decodes the decode threshold number of retrieved encoded data slices to reproduce a data segment of the data. The retrieval continues to reproduce each data segment of a plurality data segments of the data.

FIG. 9A is a flowchart illustrating an example of accessing data. In particular, a method is presented for use in conjunction with one or more functions and features described in conjunction with FIGS. 1-2, 3-8, and also FIG. 9.

The method begins at step 916 where a processing module (e.g., of an access module) receives data for storage in a dispersed storage network (DSN). The receiving may further include receiving one or more of a data identifier, a data owner identifier, a requesting entity identifier, a DSN address, baseline parameters, or a data type indicator. The method continues at step 918 where the processing module selects a set of storage units. The selecting may be based on one or more of a lookup, the data owner identifier, a vault identifier, the requesting entity identifier, or the data type indicator. The method continues at step 920 where the processing module identifies a baseline pillar width and a baseline decode threshold. The identifying the based on one or more of a lookup, the data owner identifier, the vault ID, the requesting entity ID, or the data type indicator. The method continues at step 922 where the processing module determines estimated performance of the set of storage units. The determining may include one or more of receiving, performing a lookup, initiating a query, initiating a test, accessing a historical record, or retrieving a predetermination.

The method continues at step 924 where the processing module determines a parameter multiple based on the estimated performance and the baseline pillar width and the baseline decode threshold. The determining is based on optimizing expected access performance such that a decode threshold number of encoded data slices can be retrieved from selected storage units of the DSN with favorable performance. Alternatively, the determining is based on optimizing expected access performance such that at least a write threshold number of encoded data slices can be stored to the set of storage units of the DSN with favorable performance. The method continues at step 926 where the processing module multiplies the parameter multiple by each of the baseline pillar width and the baseline decode threshold to produce a pillar width and a decode threshold respectively. The method continues at step 928 where the processing module encodes the data using a dispersed storage error coding function in accordance with the pillar width and the decode threshold to produce a plurality of sets of encoded data slices. The method continues at step 930 where the processing module facilitates storage of the plurality of sets of encoded data slices in the set of storage units. The facilitating includes issuing write slice requests to each storage unit of the set of storage units, where each storage unit receives a parameter multiple number of encoded data slices. The method continues at step 932 where the processing module stores the parameter multiple. The storing includes one or more of storing the parameter multiple in a local memory, a vault, and a directory, or in a hierarchical dispersed index.

When retrieving the data, the method continues at step 934 where the processing module receives a retrieval request for the data. The method continues at step 936 where the processing module reproduces the pillar width and the decode threshold based on the parameter multiple. The reproducing includes retrieving the baseline decode threshold and the baseline pillar width, recovering the parameter multiple, and multiplying the parameter multiple by the baseline decode threshold and the baseline pillar width to reproduce the decode threshold and the pillar width. The method continues at step 938 where the processing module identifies the set of storage units (e.g., receive identifiers, performing a lookup based on a data identifier, etc.). The method continues at step 940 where the processing module determines estimated performance of the set of storage units.

The method continues at step 942 where the processing module selects one or more storage units of the set of storage units based on the estimated performance, the parameter multiple, and the decode threshold. For example, the processing module starts with best-performing storage units to retrieve a parameter multiple number of encoded data slices from each storage unit until a decode threshold number of encoded data slices can be retrieved. The method continues at step 944 where the processing module recovers the decode threshold number of encoded data slices from the selected one or more storage units. The recovering includes issuing read slice requests, receiving read slice responses, where read slice responses from the storage unit includes a parameter multiple number of encoded data slices. The method continues at step 946 where the processing module decodes the decode threshold number of encoded data slices using the dispersed storage error coding function to reproduce the data (e.g., a data segment of a plurality of data segments of the data).

The method described above in conjunction with the processing module can alternatively be performed by other modules of the dispersed storage network or by other computing devices. In addition, at least one memory section (e.g., a non-transitory computer readable storage medium) that stores operational instructions can, when executed by one or more processing modules of one or more computing devices of the dispersed storage network (DSN), cause the one or more computing devices to perform any or all of the method steps described above.

It is noted that terminologies as may be used herein such as bit stream, stream, signal sequence, etc. (or their equivalents) have been used interchangeably to describe digital information whose content corresponds to any of a number of desired types (e.g., data, video, speech, audio, etc. any of which may generally be referred to as ‘data’).

As may be used herein, the terms “substantially” and “approximately” provides an industry-accepted tolerance for its corresponding term and/or relativity between items. Such an industry-accepted tolerance ranges from less than one percent to fifty percent and corresponds to, but is not limited to, component values, integrated circuit process variations, temperature variations, rise and fall times, and/or thermal noise. Such relativity between items ranges from a difference of a few percent to magnitude differences. As may also be used herein, the term(s) “configured to”, “operably coupled to”, “coupled to”, and/or “coupling” includes direct coupling between items and/or indirect coupling between items via an intervening item (e.g., an item includes, but is not limited to, a component, an element, a circuit, and/or a module) where, for an example of indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”. As may even further be used herein, the term “configured to”, “operable to”, “coupled to”, or “operably coupled to” indicates that an item includes one or more of power connections, input(s), output(s), etc., to perform, when activated, one or more its corresponding functions and may further include inferred coupling to one or more other items. As may still further be used herein, the term “associated with”, includes direct and/or indirect coupling of separate items and/or one item being embedded within another item.

As may be used herein, the term “compares favorably”, indicates that a comparison between two or more items, signals, etc., provides a desired relationship. For example, when the desired relationship is that signal 1 has a greater magnitude than signal 2, a favorable comparison may be achieved when the magnitude of signal 1 is greater than that of signal 2 or when the magnitude of signal 2 is less than that of signal 1. As may be used herein, the term “compares unfavorably”, indicates that a comparison between two or more items, signals, etc., fails to provide the desired relationship.

As may also be used herein, the terms “processing module”, “processing circuit”, “processor”, and/or “processing unit” may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. The processing module, module, processing circuit, and/or processing unit may be, or further include, memory and/or an integrated memory element, which may be a single memory device, a plurality of memory devices, and/or embedded circuitry of another processing module, module, processing circuit, and/or processing unit. Such a memory device may be a read-only memory, random access memory, volatile memory, non-volatile memory, static memory, dynamic memory, flash memory, cache memory, and/or any device that stores digital information. Note that if the processing module, module, processing circuit, and/or processing unit includes more than one processing device, the processing devices may be centrally located (e.g., directly coupled together via a wired and/or wireless bus structure) or may be distributedly located (e.g., cloud computing via indirect coupling via a local area network and/or a wide area network). Further note that if the processing module, module, processing circuit, and/or processing unit implements one or more of its functions via a state machine, analog circuitry, digital circuitry, and/or logic circuitry, the memory and/or memory element storing the corresponding operational instructions may be embedded within, or external to, the circuitry comprising the state machine, analog circuitry, digital circuitry, and/or logic circuitry. Still further note that, the memory element may store, and the processing module, module, processing circuit, and/or processing unit executes, hard coded and/or operational instructions corresponding to at least some of the steps and/or functions illustrated in one or more of the Figures. Such a memory device or memory element can be included in an article of manufacture.

One or more embodiments have been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claims. Further, the boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality.

To the extent used, the flow diagram block boundaries and sequence could have been defined otherwise and still perform the certain significant functionality. Such alternate definitions of both functional building blocks and flow diagram blocks and sequences are thus within the scope and spirit of the claims. One of average skill in the art will also recognize that the functional building blocks, and other illustrative blocks, modules and components herein, can be implemented as illustrated or by discrete components, application specific integrated circuits, processors executing appropriate software and the like or any combination thereof.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

The one or more embodiments are used herein to illustrate one or more aspects, one or more features, one or more concepts, and/or one or more examples. A physical embodiment of an apparatus, an article of manufacture, a machine, and/or of a process may include one or more of the aspects, features, concepts, examples, etc. described with reference to one or more of the embodiments discussed herein. Further, from figure to figure, the embodiments may incorporate the same or similarly named functions, steps, modules, etc. that may use the same or different reference numbers and, as such, the functions, steps, modules, etc. may be the same or similar functions, steps, modules, etc. or different ones.

Unless specifically stated to the contra, signals to, from, and/or between elements in a figure of any of the figures presented herein may be analog or digital, continuous time or discrete time, and single-ended or differential. For instance, if a signal path is shown as a single-ended path, it also represents a differential signal path. Similarly, if a signal path is shown as a differential path, it also represents a single-ended signal path. While one or more particular architectures are described herein, other architectures can likewise be implemented that use one or more data buses not expressly shown, direct connectivity between elements, and/or indirect coupling between other elements as recognized by one of average skill in the art.

The term “module” is used in the description of one or more of the embodiments. A module implements one or more functions via a device such as a processor or other processing device or other hardware that may include or operate in association with a memory that stores operational instructions. A module may operate independently and/or in conjunction with software and/or firmware. As also used herein, a module may contain one or more sub-modules, each of which may be one or more modules.

As may further be used herein, a computer readable memory includes one or more memory elements. A memory element may be a separate memory device, multiple memory devices, or a set of memory locations within a memory device. Such a memory device may be a read-only memory, random access memory, volatile memory, non-volatile memory, static memory, dynamic memory, flash memory, cache memory, and/or any device that stores digital information. The memory device may be in a form a solid state memory, a hard drive memory, cloud memory, thumb drive, server memory, computing device memory, and/or other physical medium for storing digital information.

While particular combinations of various functions and features of the one or more embodiments have been expressly described herein, other combinations of these features and functions are likewise possible. The present disclosure is not limited by the particular examples disclosed herein and expressly incorporates these other combinations.

What is claimed is:

1. A method for execution by one or more processing modules of one or more computing devices of a dispersed storage network (DSN), the method comprises:
receiving data for storage in the dispersed storage network (DSN);
selecting a set of storage units;
identifying a baseline pillar width and a baseline decode threshold;
determining an estimated performance of the set of storage units;
determining a parameter multiple based on the estimated performance and the baseline pillar width and the baseline decode threshold;
multiplying the parameter multiple by each of the baseline pillar width and the baseline decode threshold to produce a pillar width and a decode threshold respectively;
encoding the data using a dispersed storage error coding function in accordance with the pillar width and the decode threshold to produce a plurality of sets of encoded data slices;
facilitating storage of the plurality of sets of encoded data slices in the set of storage units; and
storing the parameter multiple.

2. The method of claim 1, wherein the receiving further includes receiving one or more of a data identifier, a data owner identifier, a requesting entity identifier, a DSN address, baseline parameters, or a data type indicator.

3. The method of claim 1, wherein the selecting may be based on one or more of a lookup, a data owner identifier, a vault identifier, a requesting entity identifier, or a data type indicator.

4. The method of claim 1, wherein the identifying is based on one or more of a lookup, a data owner identifier, a vault ID, a requesting entity ID, or a data type indicator.

5. The method of claim 1, wherein the determining an estimated performance includes one or more of: receiving the estimated performance, performing a lookup, initiating a query, initiating a test, accessing a historical record, or retrieving a predetermination.

6. The method of claim 1, wherein the determining a parameter multiple is based on optimizing expected access performance such that a decode threshold number of encoded data slices can be retrieved from selected storage units of the DSN with favorable performance.

7. The method of claim 1, wherein the determining a parameter multiple is based on optimizing expected access performance such that at least a write threshold number of encoded data slices can be stored to the set of storage units of the DSN with favorable performance.

8. The method of claim 1, wherein the facilitating includes issuing write slice requests to each storage unit of the set of storage units, where each storage unit receives a parameter multiple number of encoded data slices.

9. The method of claim 1, wherein the storing includes one or more of storing the parameter multiple in a local memory, a vault, and a directory, or in a hierarchical dispersed index.

10. The method of claim 1 further comprising, for a retrieval request for the data:
reproduce the pillar width and the decode threshold based on the parameter multiple;
identify the set of storage units;
determine an estimated performance of the set of storage units;
select one or more storage units of the set of storage units based on the estimated performance, the parameter multiple, and the decode threshold;
recover a decode threshold number of encoded data slices from the selected one or more storage units; and
decode the decode threshold number of encoded data slices using the dispersed storage error coding function to reproduce the data.

11. A method for execution by one or more processing modules of one or more computing devices of a dispersed storage network (DSN), the method comprises:
receiving a retrieval request for data;
reproducing a pillar width and a decode threshold based on a parameter multiple;
identifying a set of storage units;
determining an estimated performance of the set of storage units;
selecting one or more storage units of the set of storage units based on the estimated performance, the parameter multiple, and the decode threshold;
recovering a decode threshold number of encoded data slices from the selected one or more storage units; and
decoding the decode threshold number of encoded data slices using a dispersed storage error coding function to reproduce the data.

12. The method of claim 11, wherein the reproducing includes retrieving a baseline decode threshold and a baseline pillar width, recovering the parameter multiple, and multiplying the parameter multiple by the baseline decode threshold and the baseline pillar width to reproduce the decode threshold and the pillar width.

13. The method of claim 11, wherein the identifying the set of storage units includes any of: receive identifiers or performing a lookup based on a data identifier.

14. The method of claim 11, wherein the selecting one or more storage units of the set of storage units begins with best-performing storage units to retrieve a parameter multiple number of encoded data slices from each storage unit until the decode threshold number of encoded data slices can be retrieved.

15. The method of claim 11, wherein the recovering includes issuing read slice requests, receiving read slice responses, where read slice responses from the selected one or more storage units includes a parameter multiple number of encoded data slices.

16. The method of claim 11, wherein the data includes a data segment of a plurality of data segments of the data.

17. A computing device of a group of computing devices of a dispersed storage network (DSN), the computing device comprises:
an interface;
a local memory; and
a processing module operably coupled to the interface and the local memory, wherein the processing module functions to:
receive data for storage in the dispersed storage network (DSN);
select a set of storage units;
identify a baseline pillar width and a baseline decode threshold;
determine an estimated performance of the set of storage units;
determine a parameter multiple based on the estimated performance and the baseline pillar width and the baseline decode threshold;
multiply the parameter multiple by each of the baseline pillar width and the baseline decode threshold to produce a pillar width and a decode threshold respectively;
encode the data using a dispersed storage error coding function in accordance with the pillar width and the decode threshold to produce a plurality of sets of encoded data slices;
facilitate storage of the plurality of sets of encoded data slices in the set of storage units; and
store the parameter multiple.

18. The computing device of claim 17, wherein the determining an estimated performance includes one or more of: receiving the estimated performance, performing a lookup, initiating a query, initiating a test, accessing a historical record, or retrieving a predetermination.

19. The computing device of claim 17, wherein the determining a parameter multiple is based on optimizing expected access performance such that a decode threshold number of encoded data slices can be retrieved from selected storage units of the DSN with favorable performance.

20. The computing device of claim 17, wherein the processing module is further configured to, for a retrieval request for the data:
reproduce the pillar width and the decode threshold based on the parameter multiple;
identify the set of storage units;
determine an estimated performance of the set of storage units;
select one or more storage units of the set of storage units based on the estimated performance, the parameter multiple, and the decode threshold;
recover a decode threshold number of encoded data slices from the selected one or more storage units; and
decode the decode threshold number of encoded data slices using the dispersed storage error coding function to reproduce the data.
